(19) United States
(12) Patent Application Publication
(10) Pub. No.: US 2014/0006901 A1
(43) Pub. Date: Jan. 2, 2014

(54) MEMORY SYSTEM

(71) Applicant: SK HYNIX INC., Icheon-si Gyeonggi-do (KR)

(72) Inventors: Young Suk MOON, Icheon-si (KR); Hyung Dong LEE, Icheon-si (KR); Yong Kee KWON, Icheon-si (KR); Hyung Gyun YANG, Icheon-si (KR)

(73) Assignee: SK HYNIX INC., Icheon-si Gyeonggi-do (KR)

(21) Appl. No.: 13/720,530

(22) Filed: Dec. 19, 2012

(30) Foreign Application Priority Data
Jun. 28, 2012 (KR) 10-2012-0069991

(51) Int. Cl. G06F 11/10

(52) U.S. Cl. CPC G06F 11/10
USPC 714/766

(57) ABSTRACT

A memory system includes a processor and a plurality of memories. The processor includes a plurality of ECCs having different error restoration rates with each other, and a plurality of memories is coupled to the plurality of ECCs, respectively, according to distances from the processor.

### CROSS-REFERENCES TO RELATED APPLICATION

The present application claims priority under 35 U.S.C. §119(a) to Korean application number 10-2012-0069991, filed on Jun. 28, 2012, in the Korean Intellectual Property Office, which is incorporated herein by reference in its entirety.

### BACKGROUND

1. Technical Field

The present invention generally relates to a semiconductor apparatus, and more particularly, to a memory system in which a plurality of chips or dies are stacked.

2. Related Art

In order to increase the degree of integration of a semiconductor apparatus, a three-dimensional (3D) semiconductor apparatus configured in such a manner as to increase the degree of integration by stacking and packaging a plurality of chips in a single package has been developed. The 3D semiconductor apparatus can achieve a maximum degree of integration in the same space by vertically stacking two or more chips.

In addition, in order to improve the operating performance, a memory system including a memory controller or processor has been developed. The memory system includes a memory core to store data, wherein the memory core is configured to be able to communicate with a host through the memory controller or processor.

Meanwhile, a memory device may not properly store data due to an environmental cause or physical defect, and may thus generate an error bit. An error check/correction circuit (ECC) is included to detect whether or not an error bit is generated and to correct a generated error bit when the error bit is generated.

FIG. 1 is a diagram schematically illustrating the configuration of a convention memory system. In FIG. 1, a memory system is constituted by a plurality of stacked memory dies MEMORY1 to MEMORY4 and a processor. The processor communicates with a host (not shown), and relays communication between the stacked memory dies MEMORY1 to MEMORY4 and a host. Therefore, although the memory dies MEMORY1 to MEMORY4 individually operate at mutually different time points, the processor must perform communication between the memory dies MEMORY1 to MEMORY4 and the host at all times.

It is unavoidable for the processor to be heated to a high temperature due to the continuous operation thereof, and the heating temperature of the processor exerts an influence on the stacked memory dies MEMORY1 to MEMORY4. As the distance from the processor is nearer, the influence by the temperature becomes greater. For example, as illustrated in FIG. 1, when the processor is heated to 120 degrees, under the influence thereof, the first memory die MEMORY1 may be heated up to 115 degrees, the second memory die MEMORY2 may be heated up to 105 degrees, the third memory die MEMORY3 may be heated up to 95 degrees, and the fourth memory die MEMORY4 may be heated up to 80 degrees. Since the memory dies MEMORY1 to MEMORY4 are susceptible of temperature, heating to a high temperature increases the possibility of malfunction. In FIG. 1, since the first memory die MEMORY1 is heated to the highest temperature, an error may occur at 7% thereof, while the fourth memory die MEMORY4 heated to the lowest temperature may have an error at 0.5% thereof (See FIG. 1 for 2.0% and 4.0% Error Generation Rates).

Generally, the stacked memory dies include additional memory cells for storing parity bits, which is transmitted from an ECC, to correct error bits.

| Error restoration rate | Aea Load |
|---|---|
| 10% | 30% |
| 5% | 20% |
| 3% | 15% |
| 1% | 10% |

Table 1 shows the area load of a memory die depending on error restoration rates. As shown in Table 1, it can be understood that as the error restoration rate increases, the area load of a memory die increases because an additional memory cell is added to the memory die.

Therefore, when all stacked memory dies are configured to have the highest error restoration to be suitable for the first memory die MEMORY1 having the highest error generation rate, the area load of the memory dies increases. In contrast, when all the memory dies are configured to have, of example, an error restoration rate of 5% by taking the area load into consideration, an error of a memory die stacked near to the processor may not be corrected.

### SUMMARY

In order to solve the problem as described above, a memory system capable of setting the error restoration rates of memories to different values in proportion to the distances between a processor and stacked chips is described herein.

In an embodiment, a memory system includes: a processor configured to include a plurality of ECCs having different error restoration rates with each other; and a plurality of memories configured to be coupled to the plurality of ECCs, respectively, according to distances from the processor.

In an embodiment, a memory system includes: a processor configured to include a first ECC having a first error restoration rate and a second ECC having a second error restoration rate which is higher than the first error restoration rate; a first memory configured to be stacked on top of the processor, and to be coupled to the first ECC; and a second memory configured to be stacked on top of the first memory, and to be coupled to the second ECC.

In an embodiment, a memory system includes: a processor configured to perform data input/output communication; a logic die configured to communicate with the processor, and to include a first ECC having a first error restoration rate and a second ECC having a second error restoration rate which is higher than the first error restoration rate; a first memory die configured to be stacked on top of the logic die, and to be coupled to the first ECC; and a second memory die configured to be stacked on top of the first memory die, and to be coupled to the second ECC.

### BRIEF DESCRIPTION OF THE DRAWINGS

Features, aspects, and embodiments are described in conjunction with the attached drawings, in which:

FIG. 1 is a diagram schematically illustrating the configuration of a convention memory system, and the temperatures and error generation rates of memory dies according to stacking locations;

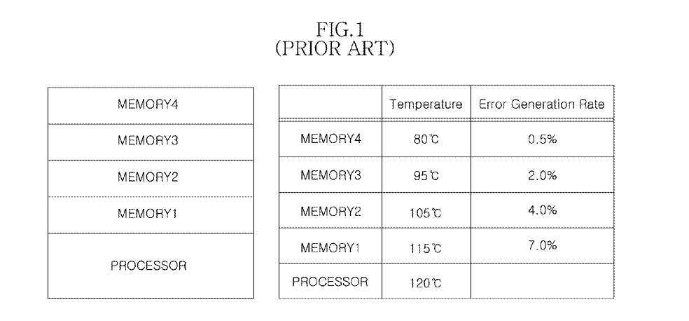

FIG. 2 is a diagram schematically illustrating the configuration of a memory system according to an embodiment;

FIG. 3 is a more detained diagram illustrating the configuration of the memory system according to an embodiment; and

FIG. 4 is a diagram illustrating the configuration of a memory system according to an embodiment.

### DETAILED DESCRIPTION

Hereinafter, a memory system according to the various embodiments will be described below with reference to the accompanying drawings through the embodiments.

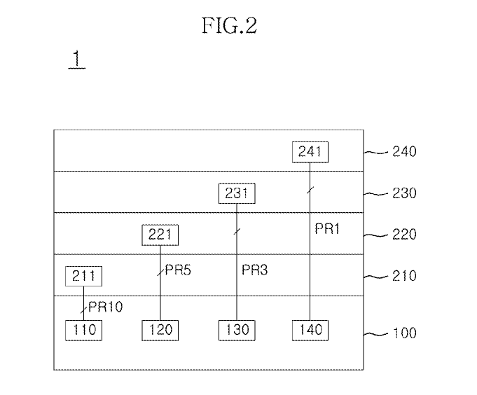

FIG. 2 is a diagram schematically illustrating the configuration of a memory system 1 according to an embodiment. In FIG. 2, the memory system 1 may include a processor 100, a first memory die 210, a second memory die 220, a third memory die 230, and a fourth memory die 240. The processor 100 relays communication between a host (not shown) and the first to fourth memory dies 210 to 240.

The first memory die 210 may be stacked on top of the processor 100, the second memory die 220 may be stacked on top of the first memory die 210, the third memory die 230 may be stacked on top of the second memory die 220, and the fourth memory die 240 may be stacked on top of the third memory die 230. The processor 100 and the first to fourth memory dies 210 to 240 can be packaged in a single package to configure a system-in-package.

The processor 100 may include a plurality of error correction circuits (ECCs) 110 to 140 having mutually different error restoration rates. The ECCs are configured to generate parity bits so as to, when proper data is not stored in a memory die and an error bit occur during a data input operation, to detect and correct the occurring error bit.

The processor 100 may include the first to fourth ECCs 110 to 140. The first to fourth ECCs 110 to 140 may have first to fourth error restoration rates, respectively. The first ECC 110 can have the highest error restoration rate, and the fourth ECC 140 can have the lowest error restoration rate. The second ECC 120 can have an error restoration rate which is lower than that of the first ECC 110, and the third ECC 130 can have an error restoration rate which is lower than that of the second ECC 120 and is higher than that of the fourth ECC 140. That is to say, the first error restoration rate is the highest, and the fourth error restoration rate is the lowest. The second error restoration rate is lower than the first error restoration rate, and the third error restoration rate is lower than the second error restoration rate and is higher than the fourth error restoration rate. The error restoration rates can be defined with the number of parity bits which ECCs can generate. The parity bits are obtained by encoding data, and have information on proper data so as to, when an error bit occurs in data stored in a memory die, correct the error bit. Therefore, an ECC having a higher error restoration rate generates a greater number of parity bits, and thus can correct a greater number of data error bits.

Each of the first to fourth memory dies 210 to 240 can be coupled to an ECC having a lower error restoration rate as the stacking distance of a corresponding memory die from the processor 100 is lower. Since the first memory die 210 may be stacked at a location nearest to the processor 100, the first memory die 210 may be coupled to the first ECC 110 having the first error restoration rate which may be the highest. The second memory die 220 and third memory die 230 are coupled to the second ECC 120 and third ECC 130, respectively, and the fourth memory die 240 farthest from the processor 100 may be coupled to the fourth ECC 140 having the fourth error restoration rate which may be the lowest.

The first to fourth memory dies 210 to 240 may include additional memory cells 211, 221, 231, 241 to store parity bits PR10, PR5, PR3, and PR1, transmitted from the first to fourth ECCs 110 to 140. The first to fourth memory dies 210 to 240 must include the additional memory cells 211, 221, 231, 241 as many as numbers corresponding to the error restoration rates of the first to fourth ECCs 110 to 140, which are coupled to the first to fourth memory dies 210 to 240, respectively. Since the first memory die 210 may be coupled to the first ECC 110 having the highest error restoration rate, the first memory die 210 stores the greatest number of parity bit PR10. Therefore, the first memory die 210 of the first to fourth memory dies 210 to 240 may include the greater number of additional memory cells 211. Since the fourth memory die 240 may be coupled to the fourth ECC 140 having the lowest error restoration rate, the fourth memory die 240 stores the smallest number of parity bit PR1. Therefore, the fourth memory die 240 of the first to fourth memory dies 210 to 240 may include the smallest number of additional memory cells 241.

In a memory system according to an embodiment, ECCs having mutually different error restoration rates may be allocated depending on the stacking locations of memory dies. That is to say, in the memory system, each memory die may be coupled to an ECC having a higher error restoration rate as the memory die is located nearer to a processor, and may be coupled to an ECC having a lower error restoration rate as the memory die is located farther from a processor. In addition, a memory die coupled to an ECC having a high error restoration rate may have a relatively greater number of additional memory cells, while a memory die coupled to an ECC having a low error restoration rate may have a relatively smaller number of additional memory cells.

Table 2 shows the error generation rates, error restoration rates, and area loads of memory dies depending on the stacking locations thereof in a memory system according to an embodiment (see also FIG. 2).

| | Error Generation Rate | Error restoration rate | Area Load |
|---|---|---|---|
| 240 | 0.5% | 1% | 10% |
| 230 | 2.0% | 3% | 15% |
| 220 | 4.0% | 5% | 20% |
| 210 | 7.0% | 10% | 30% |
| | | | 18.75% |

Since the first to fourth memory dies 210 to 240 are heated to mutually different levels by the processor 100 depending on the stacking locations thereof, the first memory die 210 can have the highest error generation rate of 7.0%, the second memory die 220 has an error generation rate of 4.0%, and the third memory die 230 has an error generation rate of 2.0%. The fourth memory die 240 can has an error generation rate of 0.5%, which is the lowest.

According to an embodiment, the memory system 1 may be configured to couple the first memory die 210 having the highest error generation rate to the first ECC 110 having the highest error restoration rate so as to correct all error bits which may be generated in the first memory die 210. That is to say, the first ECC 110 having an error restoration rate of 10% can correct all error bits of the first memory die 210 having an error generation rate of 7.0%. In this case, the first memory die 210 must has the greatest number of additional memory cells 211 to store a parity bit PR10 transmitted from the first ECC 110, so that the area load thereof increases up to 30%.

Since the fourth memory die 240 has the lowest error generation rate, the fourth memory die 240 is coupled to the fourth ECC 140 having the lowest error restoration rate. Since the error generation rate of the fourth memory die 240 is merely 0.5%, coupling the fourth ECC 140 having an error restoration rate of 1% to the fourth memory die 240 is enough. Since the fourth memory die 240 has the smallest number of additional memory cells 241, the area load thereof is merely 10%.

When ECCs having mutually different error restoration rates are coupled to the first to fourth memory dies 210 to 240, all error bits generated in the memory dies can be corrected when the memory dies have an average area load of about 18.75%. The memory system according to an embodiment couples the respective stacked memory dies to ECCs having mutually different error restoration rates, and minimizes the area load required for error correction, thereby improving the reliability of operation by correcting all error bits generated during data communication while efficiently reducing the area load.

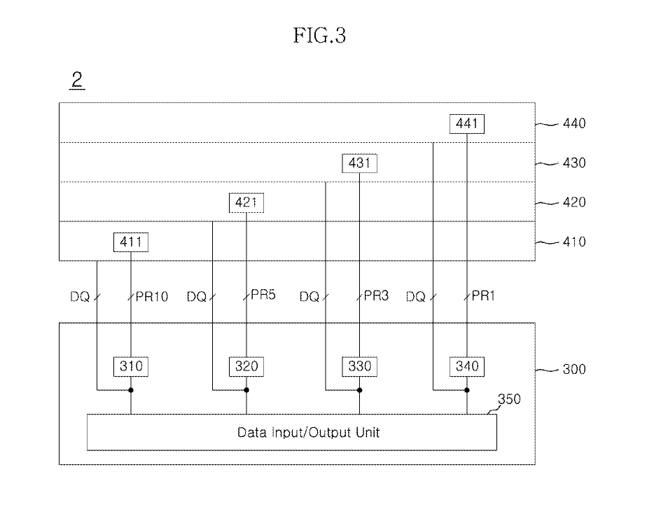

FIG. 3 is a more detailed diagram illustrating the configuration of a memory system 2 according to an embodiment. In FIG. 3, the memory system 2 may include a processor 300 and first to fourth memory dies 410 to 440, respectively. The processor 300 and the first to fourth memory dies 410 to 440 can be packaged in a single package.

The processor 300 may include a data input/output unit 350, first to fourth ECC 310 to 340, respectively. The data input/output unit 350 may be included for data communication with a host (not shown). The processor 300 may include the data input/output unit 350, can transmit data DQ transmitted from the host to the first to fourth memory dies 410 to 440, and can transmit data DQ transmitted from the first to fourth memory dies 410 to 440 to the host. The first ECC 310 has the first error restoration rate which is the highest, and the fourth ECC 340 has the fourth error restoration rate which is lowest. The second ECC 320 can have the second error restoration rate which is lower than the second error restoration rate, and the third ECC 330 can have the third error restoration rate which is lower than the second error restoration rate and is higher than the fourth error restoration rate.

The first memory die 410 may include a memory core (not shown) and first additional memory cells 411. The first memory die 410 may be coupled to the data input/output unit 350 of the processor in order to input and output data DQ. The data DQ can be stored in the memory core of the first memory die 410. The first additional memory cells 411 are coupled to the first ECC 310. The first additional memory cells 411 of the first memory die 410 store a parity bit PR10 transmitted from the first ECC 310. The first additional memory cells 411 include the greatest number of memory cells to store the greatest number of parity bits.

The second memory die 420 may include a memory core (not shown) and second additional memory cells 421. The second memory die 420 may be coupled to the data input/output unit 350 of the processor in order to input and output data DQ. The data DQ can be stored in the memory core of the second memory die 420. The second additional memory cells 421 are coupled to the second ECC 320. The second additional memory cells 421 of the second memory die 420 store a parity bit PR5 transmitted from the second ECC 320.

The third memory die 430 may include a memory core (not shown) and third additional memory cells 431. The third memory die 430 may be coupled to the data input/output unit 350 of the processor in order to input and output data DQ. The data DQ can be stored in the memory core of the third memory die 430. The third additional memory cells 431 are coupled to the third ECC 330. The third additional memory cells 431 of the third memory die 430 store a parity bit PR3 transmitted from the third ECC 330.

The fourth memory die 440 may include a memory core (not shown) and fourth additional memory cells 441. The fourth memory die 440 may be coupled to the data input/output unit 350 of the processor in order to input and output data DQ. The data DQ can be stored in the memory core of the fourth memory die 440. The fourth additional memory cells 441 are coupled to the fourth ECC 340. The fourth additional memory cells 441 of the fourth memory die 440 store a parity bit PR1 transmitted from the fourth ECC 340. The fourth additional memory cells 441 include the smallest number of memory cells to store the smallest number of parity bits PR1.

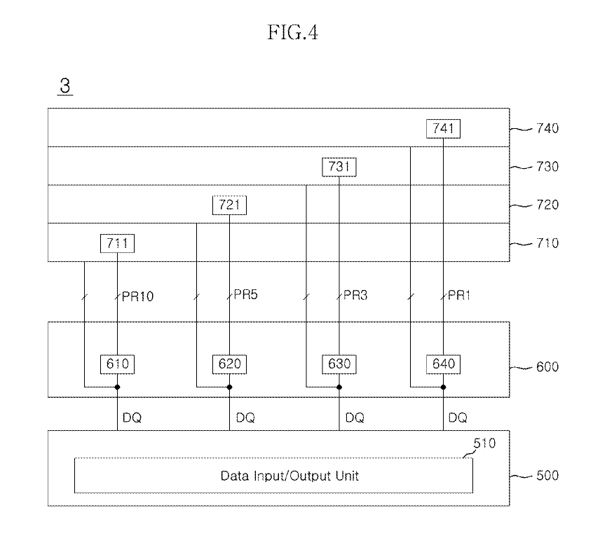

FIG. 4 is a diagram schematically illustrating the configuration of a memory system 3 according to an embodiment. In FIG. 4, the memory system 3 may include a processor 500, a logic die 600, and first to fourth memory dies 710 to 740, respectively. The processor 500, the logic die 600, and the first to fourth memory dies 710 to 740 can be packaged in a single package.

The memory system 3 shown in FIG. 4 additionally may include the logic die 600 in comparison with the memory system 2 shown in FIG. 3. The processor 500 can be included to perform data communication with a host (not shown), and the logic die 600 can include first to fourth ECC 610 to 640, which are coupled to the first to fourth memory dies 710 to 740, respectively.

The first to fourth memory dies 710 to 740 may include first to fourth additional memory cells 711, 721, 731, and 741 to store parity bits PR10, PR5, PR3, and PR1 transmitted from the first to fourth ECC 610 to 640, respectively.

In the memory systems according to the embodiments, ECCs having mutually different error restoration rates corresponding to the error generation rates of memory dies may be coupled to the respective stacked memory dies. Therefore, it is possible to completely correct all data errors occurring in all stacked dies while minimizing the area load of the memory system.

While various embodiments have been described above, it will be understood to those skilled in the art that the embodiments described are by way of example only. Accordingly, the system described herein should not be limited based on the described embodiments.

What is claimed is:

1. A memory system comprising:
a processor configured to include a plurality of ECCs having different error restoration rates with each other; and
a plurality of memories configured to be coupled to the plurality of ECCs, respectively, according to distances from the processor.

2. The system according to claim 1, wherein a memory nearer to the processor among plurality of memories is coupled to an ECC having a higher error restoration rate among the plurality of ECCs.

3. The system according to claim 2, wherein each of the plurality of memories includes a greater number of additional memory cells when the error restoration rate of an ECC coupled thereto is higher.

4. The system according to claim 3, wherein the additional memory cells store a parity bit transmitted from the ECC.

5. The system according to claim 4, wherein the additional memory cells of the memory nearer to the processor store a greater number of parity bits than the additional memory cells of the memory further from the processor

6. The system according to claim 1, wherein the processor relays communication between the plurality of memories and a host.

7. The system according to claim 1, wherein the processor and the plurality of memories are packaged in a single package.

8. A memory system comprising:
a processor configured to include a first ECC having a first error restoration rate and a second ECC having a second error restoration rate which is higher than the first error restoration rate;
a first memory configured to be stacked on top of the processor, and to be coupled to the first ECC; and
a second memory configured to be stacked on top of the first memory, and to be coupled to the second ECC.

9. The system according to claim 8, wherein the first memory includes a greater number of additional memory cells than the second memory.

10. The system according to claim 9, wherein the additional memory cells store parity bits transmitted from the first and second ECCs.

11. The system according to claim 10, wherein the additional memory cells of the first memory store a greater number of parity bits than the additional memory cells of the second memory.

12. The system according to claim 8, wherein the processor relays communication between the first and second memories and a host.

13. The system according to claim 8, wherein the first and second memories and the processor are packaged in a single package.

14. A memory system comprising:
a processor configured to perform data input/output communication;
is a logic die configured to communicate with the processor, and to include a first ECC having a first error restoration rate and a second ECC having a second error restoration rate which is higher than the first error restoration rate;
a first memory die configured to be stacked on top of the logic die, and to be coupled to the first ECC; and
a second memory die configured to be stacked on top of the first memory die, and to be coupled to the second ECC.

15. The system according to claim 14, wherein the first memory die includes a greater number of additional memory cells than the second memory die.

16. The system according to claim 15, wherein the additional memory cells store parity bits transmitted from the first and second ECCs.

17. The system according to claim 16, wherein the additional memory cells of the first memory die store a greater number of parity bits than the additional memory cells of the second memory die.

18. The system according to claim 15, wherein the processor relays communication between the logic die and a host.

19. The system according to claim 15, wherein the processor, the logic die, and the first and second memory dies are packaged in a single package.
